(19) United States
(12) Patent Application Publication
(10) Pub. No.: US 2025/0373924 A1
(43) Pub. Date: Dec. 4, 2025

(54) IMAGING METHOD, IMAGE PROCESSING APPARATUS, IMAGING APPARATUS, AND SYSTEM

(71) Applicant: Panasonic Intellectual Property Management Co., Ltd., Osaka (JP)

(72) Inventors: Takaaki YAMASAKI, Osaka (JP); Shinichi YAMAMOTO, Osaka (JP)

(73) Assignee: Panasonic Intellectual Property Management Co., Ltd., Osaka (JP)

(21) Appl. No.: 19/219,369

(22) Filed: May 27, 2025

(30) Foreign Application Priority Data
May 29, 2024 (JP) 2024-087338

(51) Int. Cl. H04N 23/61; H04N 23/62; H04N 23/84

(52) U.S. Cl. CPC H04N 23/61; H04N 23/62; H04N 23/84

(57) ABSTRACT

An imaging method includes: capturing, by an image sensor, a subject image to generate a captured image; performing, by an image processor, image processing on the captured image generated by the image sensor; and controlling, by a controller, the image processing by the image processor, based on the captured image, wherein the controller acquires at least one user instruction designating a subject in a video generated from the captured image, and causes the image processor to perform the image processing to generate the video including a processed image having an image effect different between an inside and an outside of a subject region corresponding to the subject designated by the user instruction in the captured image.

### TECHNICAL FIELD

The present disclosure relates to an imaging method, an image processing apparatus, an imaging apparatus, and a system that perform image processing on a captured image.

### BACKGROUND ART

JP 2006-211525 A discloses an imaging apparatus that has an object of enabling, at the time of shooting, color conversion to leave a color freely designated by the user and erase other color components with simple operation. In this imaging apparatus, a designated color of the user is determined based on color information included in a predetermined region of an image being displayed in an electronic viewfinder that displays an image based on image data captured by an image sensor and output from an image processor. Then, the imaging apparatus sets a parameter of the image processor so as to perform color conversion in which a color other than a determined designated color is erased.

### SUMMARY

The present disclosure provides an imaging method, an image processing apparatus, an imaging apparatus, and a system that can facilitate to realize a desired image effect on a captured subject.

In the present disclosure, an imaging method includes: capturing, by an image sensor, a subject image to generate a captured image; performing, by an image processor, image processing on the captured image generated by the image sensor; and controlling, by a controller, the image processing by the image processor, based on the captured image, wherein the controller acquires at least one user instruction designating a subject in a video generated from the captured image, and causes the image processor to perform the image processing to generate the video including a processed image having an image effect different between an inside and an outside of a subject region corresponding to the subject designated by the user instruction in the captured image.

In the present disclosure, an image processing apparatus includes: a receiver that receives image data including a captured image by an imaging apparatus capturing a subject image; an image processor that performs image processing on the captured image included in the image data received by the receiver; and a controller that controls the image processing by the image processor, based on the captured image, wherein the controller acquires at least one user instruction designating a subject in a video generated from the captured image, and causes the image processor to perform image processing to generate the video including a processed image having an image effect different between an inside and an outside of a subject region corresponding to the subject indicated by the user instruction in the captured image.

In the present disclosure, an imaging apparatus includes: an image sensor that captures a subject image to generate a captured image; an image processor that performs image processing on the captured image generated by the image sensor; and a controller that controls the image processing by the image processor, based on the captured image wherein the controller acquires at least one user instruction designating a subject in a video generated from the captured image, and causes the image processor to perform the image processing to generate the video including a processed image having an image effect between an inside and an outside of a subject region corresponding to the subject designated by the user instruction in the captured image.

In the present disclosure, an imaging system includes: the imaging apparatus with the image processor as a first image processor; and an image processing apparatus, wherein the imaging apparatus further comprises a transmitter that transmits image data indicating the captured image to the image processing apparatus, the image processing apparatus comprises: a receiver that receives the image data from the imaging apparatus; and a second image processor that performs, based on the image data received by the receiver, the image processing on the captured image indicated by the image data, and the imaging apparatus or the image processing apparatus: acquires at least one user instruction designating the subject in the video generated from the captured image; and causes the image processing to generate the video including the processed image having the image effect different between the inside and the outside of the subject region corresponding to the subject designated by the user instruction in the captured image.

According to the imaging method, the image processing apparatus, the imaging apparatus, and the system of the present disclosure, it is possible to facilitate to realize a desired image effect on a captured subject.

### BRIEF DESCRIPTION OF DRAWINGS

FIG. 1 is a diagram for explaining an imaging system according to a first embodiment of the present disclosure;

FIG. 2 is a diagram exemplifying a configuration of a digital camera in the imaging system;

FIG. 3 is a diagram exemplifying a configuration of an image processing server in the imaging system;

FIGS. 4A to 4C are diagrams for explaining operation of the imaging system of the first embodiment;

FIG. 5 is a sequence diagram illustrating operation of the imaging system in the first embodiment;

FIG. 6 is a diagram illustrating a data structure of service management information in the imaging system;

FIG. 7 is a diagram illustrating an arrangement example of a plurality of cameras in the imaging system;

FIG. 8 is a diagram for explaining detection operation of a subject region in the imaging system;

FIG. 9 is a flowchart exemplifying parallel color leaving processing in the imaging system; and

FIGS. 10A and 10B are diagrams for explaining image processing in the imaging system.

### DETAILED DESCRIPTION

Embodiments will be described in detail below with reference to the drawings as appropriate. However, more detailed description than necessary may be omitted. Note that the accompanying drawings and description below are provided to enable those skilled in the art to sufficiently understand the present disclosure, and these are not intended to limit the subject matter described in the claims.

### First Embodiment

### 1. Configuration

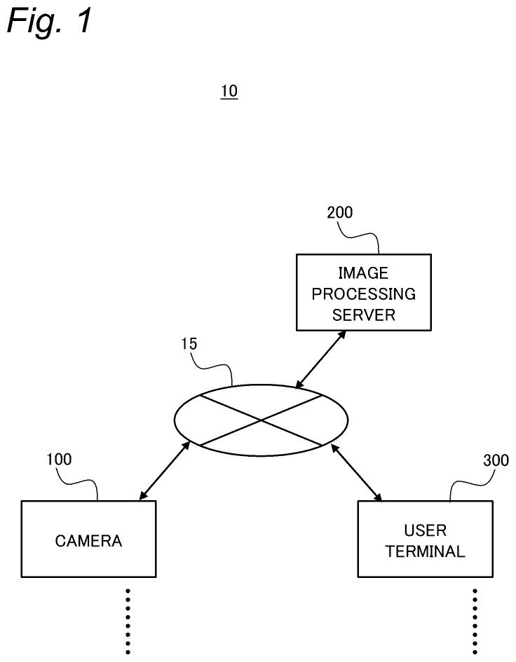

An imaging system according to a first embodiment of the present disclosure will be described with reference to FIG. 1.

As illustrated in FIG. 1, an imaging system 10 according to the present embodiment includes one or more cameras 100, an image processing server 200, and one or more user terminals 300, for example. In the present system 10, the image processing server 200 is, for example, a cloud server, data-communicably connected to the camera 100 and the user terminal 300 via a communication network 15 such as the Internet. The camera 100 and the user terminal 300 may be connected to each other in a wired or wireless manner in a manner that data communication can be performed.

For example, the present system 10 can be applied to various applications of distributing a video for a shooting result of the camera 100 to the user terminals 300. The present system 10 provides information support useful for realizing video streaming in which a subject that the user focuses on is highlighted for each of the user terminals 300.

The user terminal 300 may be various information terminals such as a personal computer (PC), a smartphone, or a tablet terminal. In the present system 10, the user terminal 300 may be omitted, and the user terminal 300 may be an external configuration of the present system 10. An output destination of a video in the present system 10 is not limited to the user terminal 300. For example, the present system 10 may store video data as output in various storage devices.

### 1-1. Configuration of Camera

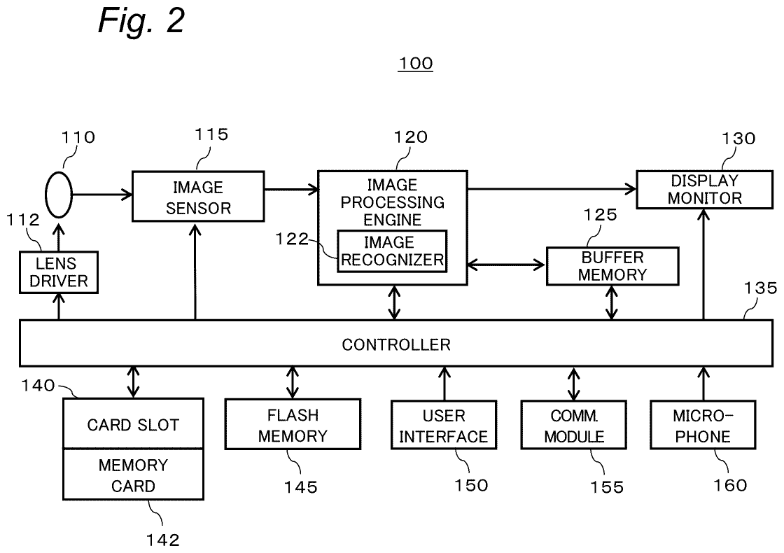

The camera 100 of the present embodiment may be various imaging apparatuses such as a digital camera, a video camera, or a camcorder. A configuration of the camera 100 in the present embodiment will be described with reference to FIG. 2.

FIG. 2 is a diagram exemplifying a configuration of the camera 100 in the present system 10. The camera 100 is an example of an imaging apparatus in the present embodiment. The camera 100 according to the present embodiment includes an image sensor 115, an image processing engine 120, a display monitor 130, and a controller 135. Furthermore, the camera 100 includes a buffer memory 125, a card slot 140, a flash memory 145, a user interface 150, a communication module 155, and a microphone 160. Further, the camera 100 includes an optical system 110 and a lens driver 112, for example. In the camera 100 of the present embodiment, the optical system 110 and the lens driver 112 may be external configurations, and the camera 100 may be of an interchangeable lens type.

The optical system 110 includes a focus lens, a zoom lens, an optical image stabilizer (OIS), an aperture, a shutter, and the like. The focus lens is a lens for changing a focus state of a subject image formed on the image sensor 115. The zoom lens is a lens for changing magnification of a subject image formed by the optical system. Each of the focus lens and the like includes one lens or a plurality of lenses.

The lens driver 112 drives the focus lens and the like in the optical system 110. The lens driver 112 includes a motor, and moves a focus lens along an optical axis of the optical system 110 based on control of the controller 135. A configuration for driving a focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). A generation timing of imaging data and electronic shutter operation in the image sensor 115 are controlled by the controller 135. As the image sensor 115, various image sensors such as a CMOS image sensor, a CCD image sensor, or an NMOS image sensor can be used.

The image sensor 115 executes capturing operation of a still image, capturing operation of a through image, and the like. The through image is mainly a moving image, and is displayed on the display monitor 130 in order for the user to determine a composition for capturing a still image. Each of the through image and the still image is an example of a captured image in the present embodiment. The image sensor 115 is an example of an image sensor of the present embodiment.

The image processing engine 120 performs various processing on imaging data output from the image sensor 115 to generate image data, and performs various processing on image data to generate an image to be displayed on the display monitor 130. Examples of the various processing include white balance correction, gamma correction, YC conversion processing, electronic zoom processing, compression processing, and decompression processing, but the processing is not limited to these examples. The image processing engine 120 may be configured by a hard-wired electronic circuit, or may be configured by a microcomputer using a program, a processor, or the like.

In the present embodiment, the image processing engine 120 includes an image recognizer 122 that realizes a function of detecting a region where a specific subject such as a person is located by image recognition of a captured image. For example, the image recognizer 122 includes a trained model constructed to perform image recognition such as segmentation by machine learning such as a neural network. The image processing engine 120 may be configured integrally with the controller 135, or the image processing engine 120 may be omitted from the camera 100.

The display monitor 130 is an example of a display that displays various information. For example, the display monitor 130 displays an image (through image) indicated by image data captured by the image sensor 115 and subjected to image processing by the image processing engine 120. The display monitor 130 displays a menu screen or the like for the user to perform various settings for the camera 100. The display monitor 130 can be configured by a liquid crystal display device or an organic EL device, for example.

The user interface 150 is a general term for user interfaces such as hard keys such as an operation button and an operation lever provided on the exterior of the camera 100, and software keys, and receives operation by the user. For example, the user interface 150 includes a release button, a mode dial, and a touch panel. When the user interface 150 receives operation by the user, the user interface 150 transmits an operation signal corresponding to the user operation to the controller 135. The user interface 150 is an example of a setting interface of the camera 100 in the present embodiment.

The controller 135 integrally controls the entire operation of the camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Further, although not illustrated, the controller 135 may include various internal memories, and may incorporate a ROM, for example. The ROM stores various programs to be executed by the controller 135. Further, the controller 135 may incorporate a RAM that functions as a work area of a CPU.

The card slot 140 is a means into which a removable memory card 142 is inserted. The memory card 142 can be connected to the card slot 140 electrically and mechanically. The memory card 142 is an external memory including a recording element such as a flash memory in the inside. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI, IEEE 802.11, Wi-Fi, Bluetooth, and the like. The camera 100 can communicate with other devices via the communication module 155.

The microphone 160 includes a plurality of microphone elements incorporated in the camera 100, for example. For example, the microphone 160 outputs, to the controller 135, a voice signal indicating voice collected in a plurality of channels so that an arrival direction of the collected voice can be estimated. The microphone 160 that is externally attached may be used for the camera 100. The camera 100 may include a connector such as a terminal connected to the microphone 160 that is externally attached instead of or in addition to the microphone 160 that is incorporated.

### 1-2. Configuration of Image Processing Server

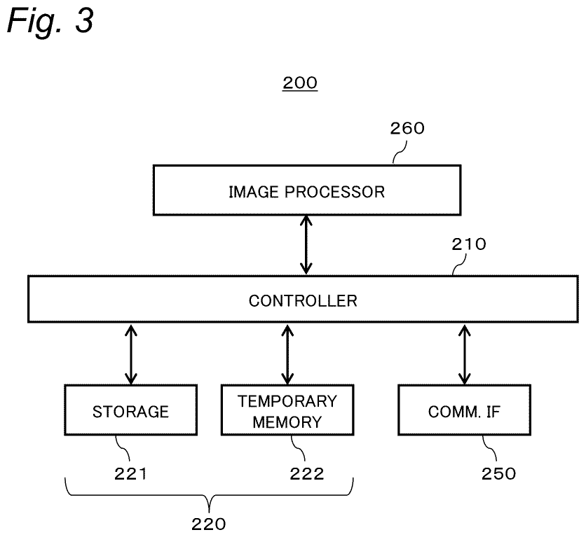

A configuration of the image processing server 200 in the present embodiment will be described with reference to FIG. 3.

FIG. 3 is a diagram exemplifying a configuration of the image processing server 200. The image processing server 200 exemplified in FIG. 3 includes a controller 210, a memory 220, a communication interface 250, and an image processor 260.

The controller 210 includes a CPU or an MPU that realizes a predetermined function in cooperation with software, for example. The controller 210 controls overall operation of the image processing server 200, for example. The controller 210 reads data and a program stored in the memory 220 and performs various arithmetic processing to realize various functions.

For example, the controller 210 executes a program including a command group for realizing each of the above-described functions. The above program may be provided from the communication network 15, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a storage medium that stores a program and data necessary for implementing a function of the image processing server 200. As illustrated in FIG. 3, the memory 220 includes a storage 221 and a temporary memory 222.

The storage 221 stores a parameter, data, a control program, and the like for realizing a predetermined function. The storage 221 includes an HDD or an SSD, for example. For example, the storage 221 stores the above-described program, various image data, and the like.

For example, the temporary memory 222 includes a RAM such as a DRAM or an SRAM, and temporarily stores (i.e., holds) data. For example, the temporary memory 222 holds image data being edited. Further, the temporary memory 222 may function as a work area of the controller 210, and may be configured by a storage area in an internal memory of the controller 210.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the image processing server 200 to a communication network such as the Internet. The communication interface 250 is an example of an input interface that receives various pieces of information from an external device or a communication network.

The image processor 260 performs various image processing on image data received from the communication interface 250 to generate processed image data, for example. The image processor 260 may be configured by a hard-wired electronic circuit, or may be configured by a microcomputer using a program, a processor, or the like.

The configuration of the image processing server 200 as described above is an example, and the configuration of the image processing server 200 is not limited to this. For example, the controller 210 and the image processor 260 may be integrally configured. The input interface in the image processing server 200 may be realized by cooperation with various software in the controller 210 and the like. An input interface in the image processing server 200 may acquire various information by reading various information stored in various storage media (e.g., the storage 221) to a work area (e.g., the temporary memory 222) of the controller 210. The image processing server 200 of the present system 10 may include a plurality of server devices.

### 2. Operation

The operation of the present system 10 configured as described above will be described below.

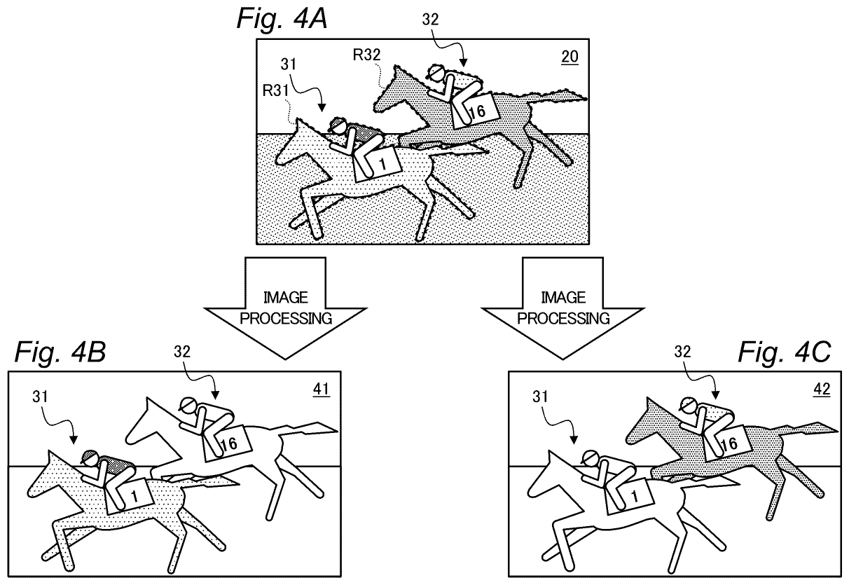

For example, the present system 10 performs image processing such as color leaving processing of leaving a color only in a specific subject by using a recognition result of a subject in the camera 100. An outline of operation of the present system 10 will be described with reference to FIGS. 4A to 4C.

FIGS. 4A to 4C are diagrams for explaining operation of the imaging system 10 of the first embodiment. For example, by changing a subject to be colored for each viewer by each of the user terminals 300, the present system 10 colors a subject that each viewer focuses on at the time of shooting for a horse racing broadcast, a sport broadcast, a live video, or the like, and performs video streaming in which a coloring target is changed for each viewer.

FIG. 4A illustrates an example of a captured image 20 in the camera 100. FIG. 4B exemplifies a processed image 41 as a result of image processing performed on the captured image 20 of FIG. 4A in the present system 10. FIG. 4C exemplifies a processed image 42 as a result of image processing, which is different from the image processing of FIG. 4B, performed on the captured image 20 of FIG. 4A.

FIG. 4A exemplifies the captured image 20 of a frame in a video (hereinafter also referred to as “original video”) shot by the camera 100 for a shooting scene having a plurality of pairs of a racehorse and a jockey of the racehorse as subjects. For convenience of explanation, the captured image 20 in which two subjects 31 and 32 appear is exemplified in FIG. 4A, but the number of the subjects 31 to 32 in the original video may be three or more.

The camera 100 of the present embodiment sequentially detects subject regions R31 to R32 along an outer shape of the subjects 31 to 32 during shooting of the original video, for example. For example, the subject regions R31 to R32 are obtained using a technique for various shooting control in the camera 100 such as automatic focusing operation (AF) or automatic exposure determination (AE).

By using the detection result of the subject regions R31 to R32, the present system 10 performs image processing on the captured image 20 to highlight the specific subject 31 as exemplified in FIGS. 4A and 4B, to generate the processed image 41. For example, the specific subject 31 is a focused subject in a certain one of the user terminals 300. For example, the image processing of the present system 10 is color leaving processing for making the outside of the subject region R31 achromatic with leaving a color inside the subject region R31 corresponding to the specific subject 31. The present system 10 distributes video data including the processed image 41 processed with the color leaving processing for the specific subject 31 to the user terminal 300 focusing on the subject 31.

FIG. 4C exemplifies the processed image 42 distributed to the user terminal 300 different from the distribution destination of FIG. 4B in the present system 10. In the present system 10, a situation is assumed that the subjects 31 and 32 different from each other are focused in the user terminals 300, for example. For such an exemplary situation, the present system 10 generates a plurality of videos (hereinafter also referred to as “processed videos”) as illustrated in FIGS. 4B and 4C from the original video in FIG. 4A, wherein the processed videos includes the processed images 41 and 42 each coloring the subjects 31 and 32 different from each other.

According to this, the present system 10 can provide a service of individually distributing the processed video each highlighting the subject 31 or 32 focused by the viewer in each of the user terminals 300. Hereinafter, an example in which the present system 10 is applied to a live streaming service of video shooting of horse racing and the like will be described.

### 2-1. Overall Operation

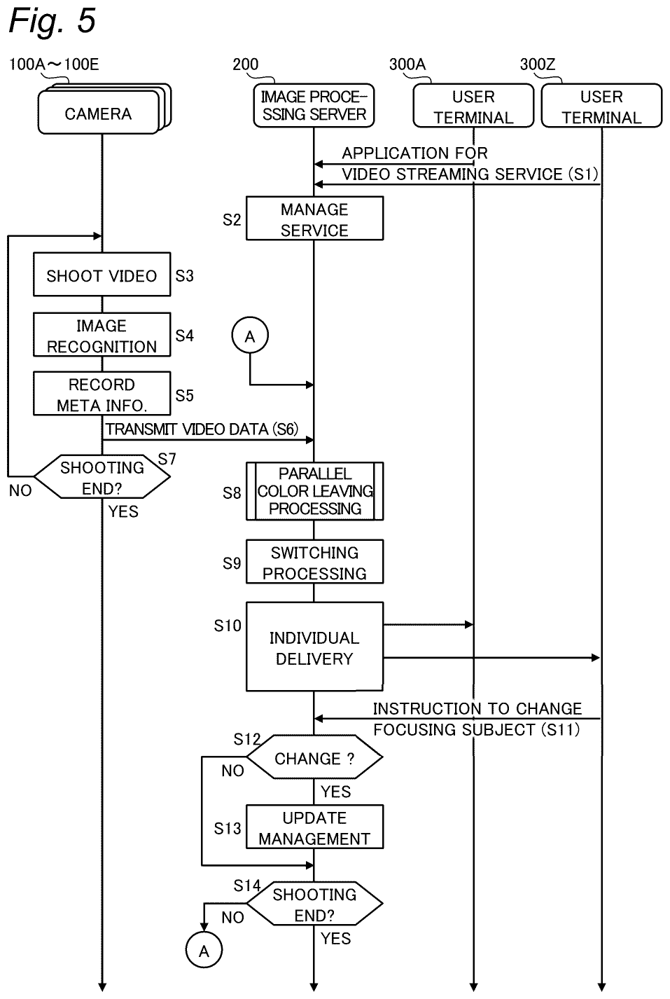

Overall operation of the camera 100 in the present system 10 will be described with reference to FIGS. 5 to 8.

FIG. 5 is a sequence diagram exemplifying operation of the present system 10, and the present system 10 provides a service of distributing a video by highlighting, e.g. a racehorse (and a jockey of the racehorse) on which the user places a bet. In the video streaming service, the system 10 may provide an option that enables a switching instruction to highlight a horse different from the racehorse on which a bet is placed in the middle of a race.

Hereinafter, an operation example for a case where each user focuses on one subject in the present system 10, that is, for a win ticket will be described. Note that the present service may be available without the user placing a bet.

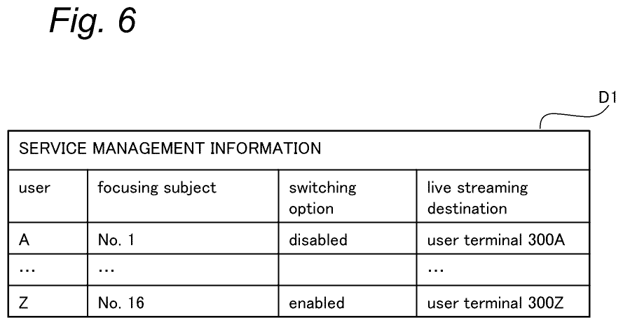

For example, in the present system 10, before video streaming, the image processing server 200 receives an application for a video streaming service from a plurality of user terminals 300A to 300Z via the communication network 15 (S1 to S2). Hereinafter, “user terminals 300A to 300Z” are collectively referred to as “user terminal 300”. The user terminal 300A is the user terminal 300 of a user A, and the user terminal 300Z is the user terminal 300 of another user Z (see FIG. 6).

A plurality of the user terminals 300A to 300Z transmit application information for a video streaming service to the image processing server 200 via the communication network 15, for example (S1). For example, the application information from each of the user terminals 300 includes identification information of a racehorse (or a focusing racehorse) for which the corresponding user places a bet, a video streaming service application, and whether or not a switching option is enabled.

When receiving application information for the video streaming service from the user terminal 300 via the communication network 15 (S1), the controller 210 of the image processing server 200 generates service management information D1 for managing application information from each of the user terminals 300 (S2). FIG. 6 exemplifies the service management information D1 in the present system 10.

For example, as illustrated in FIG. 6, the service management information D1 manages “user”, “focusing subject”, “switching option”, and “live streaming destination” in association with each other. The service management information D1 is an example of management information in the present embodiment. The service management information D1 is stored in the memory 220 of the image processing server 200, for example.

In the service management information D1, the “user” stores identification information of the user of the user terminal 300 who has applied for a video streaming service. The “focusing subject” stores identification information of a focusing target in the application information from each of the user terminals 300, and is a saddlecloth number of a racehorse, for example. The “switching option” stores whether or not switching can be performed according to an application for the switching option from each of the user terminals 300. The “live streaming destination” stores address information for distributing a video to the user, and indicates the user terminal 300 as a transmission source of the application information, for example.

In the service management information D1 of the example of FIG. 6, for the user A, it is managed that the focusing subject is the number “1”, the switching option is “disabled”, and the live streaming destination is the user terminal 300A, for example. For the user Z, it is managed that the focusing subject is the number “16”, the switching option is “enabled”, and the live streaming destination is the user terminal 300Z.

In the present system 10, the camera 100 shoots the original video in live streaming of a video, for example (S3 to S7). In the present embodiment, an operation example in which the imaging system 10 performs live streaming by using a plurality of cameras 100A to 100E will be described. Hereinafter, a generic term for “cameras 100A to 100E” is “camera 100”.

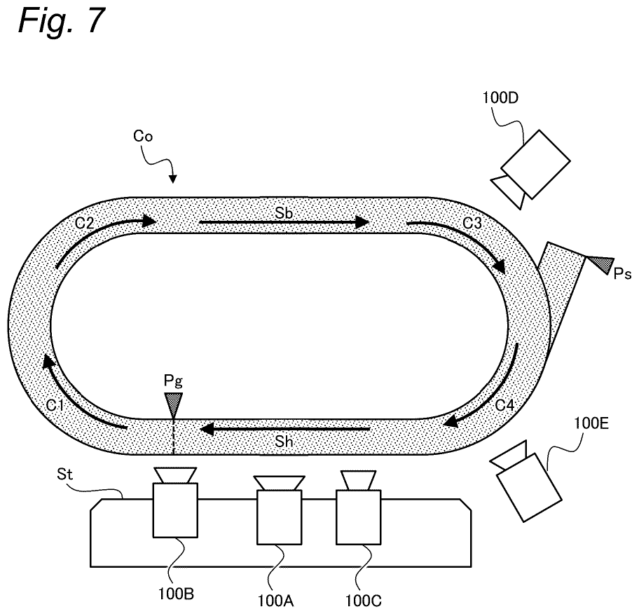

FIG. 7 illustrates an arrangement example of a plurality of the cameras 100A to 100E in the present system 10. A course Co in which a horse group of the subjects 31 to 32 runs in a racetrack includes, for example, a first corner C1, a second corner C2, a third corner C3, and a fourth corner C4 as illustrated in FIG. 7.

Furthermore, the course Co includes a start point Ps following the fourth corner, a home stretch Sh between the fourth and first corners C4 and C1, a goal point Pg between the home stretch Sh and the first corner C1, and a back stretch Sb between the second and third corners C2 and C3. Further, a stand St for spectators is provided facing the home stretch Sh.

In the example of FIG. 7, an arrangement example using five of the cameras 100A to 100E in the present system 10 is illustrated. For example, the first camera 100A is arranged so as to shoot the entire course Co from the highest position in the stand St. The second camera 100B is arranged to shoot the goal point Pg at a position lower than the first camera 100A, for example. The third camera 100C is arranged so as to shoot the back stretch Sb from a height similar to that of the first camera 100A, for example.

The fourth camera 100D is arranged outside the third corner C3 for shooting a horse group (subjects 31 to 32) passing toward the third corner C3, for example. The fifth camera 100E is arranged outside the fourth corner C4 so as to shoot a horse group at the fourth corner C4, for example. In the present system 10, the first to fifth cameras 100A to 100E perform processing (S3 to S7) of video shooting, respectively.

For example, in each of the cameras 100, first, the controller 135 causes the image sensor 115 to perform imaging operation at a predetermined frame rate (e.g., 30 to 60 fps) and generate the captured image 20 (see FIG. 4A) for each frame (S3). In the present embodiment, such video shooting operation of the camera 100 is performed, for example, using deep focus with a large depth of field in view of focusing on each of the subjects 31 to 32.

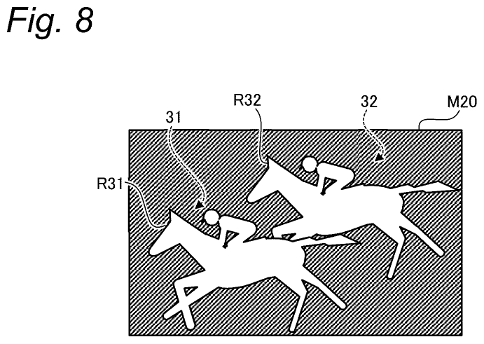

Next, the controller 135 operates the image recognizer 122 to recognize various information regarding the subjects 31 to 32 in the generated captured image 20, for example (S4). In Step S4, the image recognizer 122 detects the subject regions R31 to R32, for example. Detection operation of a subject region in the present system 10 will be described with reference to FIG. 8.

FIG. 8 exemplifies a region divided map M20 of a detection result for the captured image 20 of FIG. 4A. For example, the image recognizer 122 of the camera 100 inputs the captured image 20 for each frame from the image sensor 115 to a trained model for image recognition such as a segmentation technique, and sequentially generates the region divided map M20 from output of the trained model (S4).

The above-described trained model is constructed by machine learning so as to calculate a probability value of whether a subject of a specific type such as a racehorse (including a jockey of the racehorse) is shown for each pixel in an input image, for example. For example, in Step S4, the image recognizer 122 performs threshold determination on a probability value for each pixel in output of the trained model, and generates the region divided map M20.

At this time, even with an overlap between a plurality of the subject regions R31 to R32, the image recognizer 122 can separate the subject regions R31 to R32 from each other based on a difference in distance values in the subject regions R31 to R32 by using various distance measuring techniques in the camera 100, for example. Such distance measuring techniques may be e.g. image plane phase difference detection, DFD, or the like, or may use a distance measuring sensor such as a TOF sensor.

According to the region divided map M20, it is possible to detect the subject regions R31 and R32 having a shape along an outer shape of the subjects 31 to 32 as illustrated in FIG. 8 corresponding to the subjects 31 to 32 shown in the captured image 20 of FIG. 4A, for example. For example, the camera 100 can use any of the subject regions R31 to R32 for various types of shooting control (e.g., AE control) by using the region divided map M20 (S3).

In Step S4, the controller 135 applies an image recognition technique such as optical character recognition (OCR) to the captured image 20 to recognize identification information of a focusing subject such as the saddlecloth number “1” of the subject region R31 and the saddlecloth number “16” of the subject region R32 in FIG. 4A, for example.

Returning to FIG. 5, for example, the controller 135 records a result of the image recognition (S4) as described above as meta information of video data (S5), and transmits the video data with the meta information from the communication module 155 to the image processing server 200 via the communication network 15 (S6). The video data transmitted in Step S6 includes a predetermined number of frames in units of Group Of Picture (GOP), for example.

The controller 135 repeats the processing of Steps S3 to S6 in a predetermined cycle until the end of video shooting, for example (S7). For example, the predetermined cycle is a predetermined number of times a frame period (e.g., several seconds).

In the image processing server 200, when the communication interface 250 receives the video data from the camera 100 (S6), the controller 210 performs image processing on the received video data in parallel to generate a plurality of processed videos, for example (S8). In the parallel color leaving processing (S8) of the present embodiment, image processing such as color leaving processing is performed in parallel between a plurality of the subjects 31 to 32 so as to cover a “focusing subject” in the service management information D1 (S2), for example (see FIG. 4). Details of the processing of Step S8 will be described later.

Next, the controller 210 performs switching processing of switching and combining distribution targets in shooting results of a plurality of the cameras 100A to 100E (S9). In the present system 10, the switching processing (S9) is automatically or manually performed by grasping a progressing situation of a race from a shooting result by a plurality of the cameras 100A to 100E, for example.

For example, in the switching processing (S9), the fifth, first, or second camera 100E, 100A, or 100B is appropriately adopted according to a position of a horse group until the horse group passes through the fourth, first, and second corners C4, C1, and C2 from the start point Ps (FIG. 7) to reach the back stretch Sb. The image processing server 200 generates a composite image such that an image from the first camera 100A and an image from the third camera 100C are placed side by side at a time point at which the horse group passes through the back stretch Sb, for example.

The fourth camera 100D is adopted at a time point at which the horse group moves toward the third corner from the back stretch Sb and passes through the third corner, and then the camera is switched to the first camera 100A. At a time point at which the horse group enters the fourth corner C4, the fifth camera 100E is adopted, and when the horse group goes beyond a range of a view angle of the fifth camera 100E, the camera is switched to the first camera 100A, and when the horse group further approaches the goal point Pg, the camera is switched to the second camera 100B.

The switching processing (S9) as described above may be performed by the controller 210 performing image recognition of a shooting result of each of the cameras 100, for example. Alternatively, the switching processing may be performed in a manner that a person in charge of switching instructs the image processing server 200 of a switching timing by using a monitor that displays each video from a plurality of the cameras 100A to 100E.

Next, based on the service management information D1, the controller 210 transmits video data of an editing result (S8 and S9) of each focusing subject in the service management information D1 to each of the user terminals 300 from the communication interface 250 via the communication network 15 (S10). For example, in Step S10, video data of FIG. 4B is transmitted to the user terminal 300A in which the number “1” is registered for the focusing subject in the service management information D1. Further, video data of FIG. 4C is transmitted to the user terminal 300Z in which the number “16” is registered for the focusing subject.

For example, in the present system 10 during video streaming, an instruction to change the focusing subject can be transmitted to the image processing server 200 from the user terminal 300Z that applied for the switching option in advance (S11). In the image processing server 200, the controller 210 receives an instruction to change a focusing target from the user terminal 300 via the communication interface 250 (S12).

When receiving the instruction to change a focusing target from the user terminal 300 (YES in S12), the controller 210 updates the service management information D1 according to the instruction, for example (S13). In the service management information D1, focusing subjects before and after the change may be managed.

The controller 210 repeats the processing of Steps S8 to S13 in a predetermined cycle until the end of video shooting, for example (S14). For example, the predetermined cycle includes a plurality of frame periods.

For example, when an instruction is changed for a focusing subject (YES in S12), to the user terminal 300Z of a transmission source (S11) of the instruction, video data highlighting a focusing subject updated in Step S13 is transmitted from the image processing server 200 in Step S10 that follows. When no instruction to change a focusing subject (NO in S12), the controller 210 proceeds to Step S14 without particularly performing the processing of Step S13.

According to the above operation, the present system 10 generates, for each of the subjects 31 and 32 in the subject regions R31 and R32 recognized by the image recognition (S4) at the video shooting by the camera 100, a plurality of processed videos in which different image effects are applied between a certain subject and another subject, for example (S8). In this way, the processed videos can be obtained with the subject as a target of an image effect being changed to meet a request of a plurality of users.

Furthermore, according to the present system 10, the processed videos are distributed to each of the user terminals 300 so as to provide the user with a video having a video effect of only a subject focused by the user (S10). In this way, it becomes easy for the user to see a focusing subject, and it is possible to enhance a realistic feeling of video viewing.

### 2-2. Parallel Color Leaving Processing

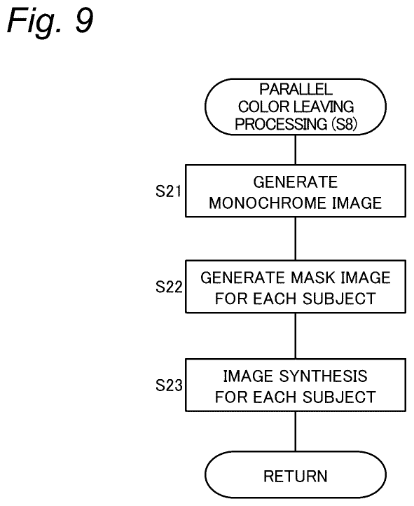

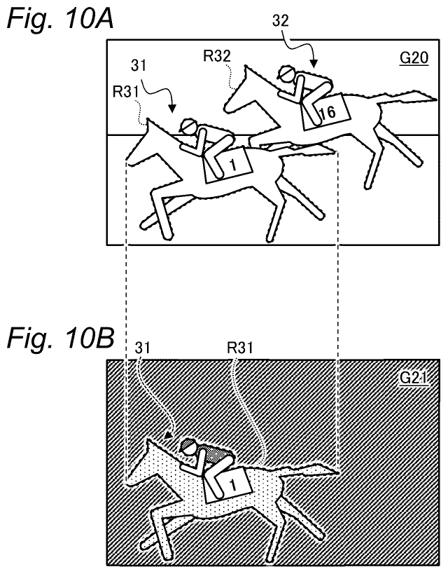

Details of the parallel color leaving processing in Step S8 of FIG. 5 will be described with reference to FIGS. 9 and 10.

FIG. 9 is a flowchart exemplifying the parallel color leaving processing in the present system 10. For example, the processing illustrated in the flow of FIG. 9 is started with the image processing server 200 storing video data received from each of the cameras 100A to 100E in Step S6 in the memory 220. FIG. 9 exemplifies processing for the captured image 20 of one frame in the original video from one of the cameras 100.

For example, the controller 210 first causes the image processor 120 to perform monochrome processing of changing a color of the captured image 20 of a frame as a processing target in the original video to an achromatic color (S21). FIG. 10A illustrates a processing result of Step S21 for the captured image 20 of FIG. 4A. In Step S21, as illustrated in FIG. 10A, the image processor 120 generates a monochrome image G20 obtained by achromatizing the captured image 20, for example.

For example, referring to the region divided map M20 (FIG. 8), the controller 210 causes the image processor 120 to perform mask processing for each of the subject regions R31 and R32 on the captured image 20 of the same frame as in Step S21 (S22). FIG. 10B exemplifies an example of a processing result of Step S22 for the captured image 20 of FIG. 4A.

In Step S22, as illustrated in FIG. 10B, the image processor 120 generates a mask image G21 obtained by extracting the inside of the subject region R31, which is one of a plurality of the subject regions R31 to R32 in the captured image 20, for example. In the example of FIG. 4A, the image processor 120 also generates a mask image of the other, the subject region R32, in a similar manner to the above.

The controller 210 can manage a mask image corresponding to each of the subjects 31 and 32 based on identification information of a subject in meta information of video data. The mask processing in Step S22 is executed in parallel for a plurality of the subject regions R31 and R32, for example. When a subject not shown in the captured image 20 is present in each frame, the mask processing on the subject can be appropriately omitted.

Furthermore, the controller 210 causes the image processor 120 to synthesis the mask image G21 (FIG. 10B) of the certain subject 31 and the monochrome image G20 (FIG. 10A) for each of the subject regions R31 to R32 (S23). In Step S23, as illustrated in FIGS. 4B and 4C, the image processor 120 generates a plurality of the processed images 41 and 42 in which a color of the subjects 31 and 32 remains, for example.

The synthesis processing in Step S23 is executed in parallel for a plurality of mask images generated in Step S22, for example. For example, the synthesis processing for each of the mask images G21 is performed so as to superimpose the mask image G21 on the monochrome image G20. In such superimposing and combining, the mask image G21 is in a layer above the monochrome image G20, and transparent attribute is adopted for a region other than a portion of the corresponding subject region R31 in the mask image G21.

For example, in the parallel color leaving processing (S8) of FIG. 5, the controller 210 executes the processing of Steps S21 to S23 illustrated in the flow of FIG. 9 for a plurality of frames from a plurality of the cameras 100A to 100E. The processing order is time order in video shooting, for example. Further, temporally simultaneous frames from the separate cameras 100A to 100E may be processed in parallel.

According to the above-described parallel color leaving processing (S8 in FIG. 5), a plurality of the processed images 41 and 42 in which a plurality of the subjects 31 and 32 are highlighted can be obtained in parallel (S23).

The parallel color leaving processing (S8 in FIG. 5) is not particularly limited to the above example, and for example, in Step S21, instead of the monochrome image G20, a plurality of mask images obtained by extracting the outside of the individual subject regions R31 and R32 may be generated, and the monochrome processing may be performed on each mask image. In this case, the processing in Step S21 may also be performed in parallel for the mask images. In Step S23 in this case, by adopting transparent attribute for an external region extracted in each mask image, the processed images 41 and 42 can be generated without particularly considering stacking order of layers. Alternatively, the processing of Step S22 may be omitted, and superimposing and combining of the captured image 20 and the mask image of Step S21 may be performed in Step S23.

For example, in step S22, image processing of applying various image effects may be performed on the mask image G21 (FIG. 10B) in which the inside of the subject region R31 is left. For example, different color correction may be performed between the inside and outside of the subject region R31, in such a manner as increasing saturation of the mask image G21 leaving the inside of the subject region R31 and decreasing saturation of another mask image.

For example, in the parallel color leaving processing (S8 in FIG. 5), the captured image 20 of one frame may be input to a plurality of image correction circuits, and image processing for the inside and the outside of a subject region may be performed in parallel in each of the image correction circuits. The processed images 41 and 42 may be generated by combining the images obtained as described above with each other.

In the above description, an operation example using the region divided map M20 obtained at the time of video shooting in the camera 100 is described. The present system 10 does not need to use the region divided map M20 by the camera 100, and for example, the controller 210 may perform subject region detection operation. In this case, distance measurement information at the time of video shooting by the camera 100 may be included in meta information of video data to be transmitted (S5 in FIG. 5).

The processing order of Steps S8 and S9 may be reversed. In this case, the processing of Step S8 may be performed on a shooting result adopted in the switching processing (S9), and processing of Step S8 may be omitted for a shooting result not adopted in the switching processing.

In the above description, an operation example in the case where each user focuses on one subject in the present system 10 is described, but the present system 10 is not limited to this, and there may be a plurality of focusing subjects of the user. For example, a betting ticket of the user is not limited to a win ticket, and may be quinella, exacta, trifecta box, trifecta, bracket quinella, or the like, and the image processing server 200 of the present system 10 may manage identification information of a plurality of subjects corresponding to the betting ticket in the service management information D1 via information communication as appropriate. The user can transmit application information from the user terminal 300 for a plurality of subjects as focusing subjects without particularly purchasing a betting ticket (S1).

In the above case, the image processing server 200 of the present system 10 can generate a processed image by simultaneously setting a plurality of subject regions as targets of highlight display in the parallel color leaving processing (S8) for subjects of a combination registered as the “focusing subject” for each user in the service management information D1, for example. Such a processed image can be transmitted from the image processing server 200 of the present system 10 to the user terminal 300 in which subjects of a combination corresponding to focusing subjects are registered in the service management information D1.

### 3. Review

As described above, the imaging method according to the present embodiment includes a step (S3) of the image sensor 115 of the camera 100 as an example of an image sensor capturing a subject image and generating the captured image 20, a step (S8) of the image processor 260 performing image processing on the captured image 20 generated by the image sensor 115, and a step of the controller 210 controlling image processing by the image processor 260 based on the captured image 20. In the present method, the controller 210 acquires application information as an example of at least one user instruction designating a subject in a video generated from the captured image 20 (S2), and causes the image processor 260 to perform image processing so as to generate a video including processed images (41 and 42) to which different image effects are imparted between the inside and the outside of a subject region (R31 and R32) corresponding to a subject designated by a user instruction in the captured image 20 in response to at least one user instruction (S8).

According to the above imaging method, image processing is performed for each of the subject regions R31 and R32 according to a user instruction, and thus it can facilitate to realize a desired image effect for a captured subject.

In the imaging method of the present embodiment, at least one user instruction includes, for example, a plurality of user instructions designating different subjects among a plurality of the subjects 31 to 32 in a video from a plurality of the user terminals 300A to 300Z. In response to a plurality of user instructions, the controller 210 controls the image processor 260 to generate a plurality of videos in which image effects are imparted to a plurality of the subject regions R31 to R32 corresponding to different subjects (S21 to S23). In this way, it is possible to generate a plurality of videos according to a plurality of user instructions and easily realize an image effect desired by the user.

In the imaging method of the present embodiment, the controller 210 acquires a user instruction via the communication interface 250 that performs data communication with at least one of the user terminals 300 corresponding to at least one user instruction. The present method further includes a step (S10) of transmitting, by the communication interface 250, video data indicating a video generated according to a user instruction to a user terminal corresponding to the user instruction.

In the imaging method of the present embodiment, the subject regions R31 and R32 are regions along outer shapes of the subjects 31 and 32 in the captured image 20. The image processor 260 generates the processed images 40 and 41 so as to make image effects different along outer shapes of the subjects 31 and 32 designated by a user instruction in the captured image 20. By this, image effects can be made different between regions along an outer shape of a subject in the captured image 20, and a desired image effect on a captured subject can be easily realized.

In the present embodiment, the imaging method further includes a step (S4) of recognizing the subject regions R31 and R32 corresponding to the subjects 31 and 32 in the captured image 20 based on the captured image 20 generated by the image sensor 115. The controller 210 causes the image processor 260 to perform image processing so as to impart an image effect on a subject region corresponding to a subject designated by a user instruction among the recognized subject regions R31 and R32 based on a recognition result of the subject regions R31 and R32 (S8). In this way, for example, a desired image effect on a captured subject can be easily realized using the image recognizer 122 of the camera 100.

In the imaging method of the present embodiment, the image effect is an effect in which color tones are separately adjusted between the inside and the outside of a subject region. According to the present system 10, a desired color tone effect can be easily realized for a captured subject.

A program including a group of commands for causing a processor such as the controller 210 to execute the imaging method of the present embodiment may be provided. Such a program may include a step of the processor acquiring the captured image 20 in which the subject image is captured.

In the present embodiment, the image processing server 200 as an example of an image processing apparatus includes the communication interface 250 as an example of a receiver that receives image data including the captured image 20 in which a subject image is captured by the camera 100, the image processor 260 that performs image processing on the captured image 20 included in image data received by the receiver, and the controller 210 that controls image processing by the image processor 260 based on the captured image 20. The controller 210 acquires at least one user instruction designating a subject in a video generated from the captured image 20 (S2), and causes the image processor to perform image processing so as to generate a video including a processed image to which different image effects are imparted between the inside and the outside of a subject region corresponding to the subject indicated by the user instruction in the captured image 20 according to at least one user instruction (S8). In this way, it is possible to easily realize a desired image effect on a captured subject.

In the image processing server 200 of the present embodiment, the communication interface 250 may receive a plurality of pieces of image data from a plurality of the cameras 100 (S6). The controller 210 may cause the image processor 260 to perform image processing so as to generate a video based on a plurality of pieces of image data received from a plurality of the cameras 100 via the communication interface 250 (S8 and S9). In this way, in a video using a plurality of the cameras 100, a desired image effect on a captured subject can be easily realized.

### Other Embodiments

As described above, the first embodiment is described as an example of the technique disclosed in the present application. However, the technique in the present disclosure is not limited to this, and is applicable to embodiments in which changes, replacements, additions, omissions, and the like are appropriately made. Further, the constituent elements described in the above-described first embodiment can also be combined to form a new embodiment.

In the first embodiment described above, an example in which the imaging system 10 is applied to live streaming of horse racing is described, but the present disclosure is not particularly limited to this. The imaging system 10 of the present embodiment is not limited to the above example, and may be applied to live streaming of various races, sports, concerts, or the like. The focusing subject in the present system 10 is not particularly limited to the example of the first embodiment, and may be a person or an animal, or may be a moving object such as a vehicle.

For example, when the present system 10 is applied to live streaming of a soccer game, a plurality of the cameras 100 may be arranged for each area in a field. For example, the camera 100 that looks down the entire field, the camera 100 that tracks a ball, a camera for shooting one goal, a camera for shooting the other goal, and a camera that shoots each of four divided areas of the field may be used. Alternatively, a plurality of the cameras 100 that track each player on the pitch may be used. At this time, a plurality of the cameras 100 in four directions or the like may be used for one player.

In such soccer video distribution or the like, the present system 10 may individually distribute a video corresponding to a request to the user with respect to a video which is not video-distributed, in addition to using video distribution as a basis by switching on the video distribution side as in the first embodiment. For example, in a state where a certain user is receiving basic video distribution of the present system 10 in which a player wearing number 10 appears, when movement of a player wearing number 2 not appearing in the distributed video also catches attention, the present system 10 may be configured to be switchable to distribution of a video in which the latter player appears from a shooting result of a plurality of the cameras 100. At this time, the present system 10 can perform image processing such as color leaving processing on the latter subject and distribute the video to the user.

As described above, for example, in a soccer broadcast, the present system 10 distributes a video that tracks a player not appearing in a video in a basic live broadcast according to a request of the user, so that when the user wants to see the movements of a player that the user himself/herself is interested in, the user can view a video that highlights the player that the user himself/herself is interested in and that is not in the basic video distribution. Such a method of the present system 10 can also be applied to distributing a video focusing on a specific singer in a singer group by the user, for example, in a concert video of the singer group.

In the above embodiment, the imaging method of generating a video including a processed image to which different image effects are imparted between the inside and the outside of a subject region corresponding to a subject designated by an instruction of the user when instructed by the user in live recording is described, but the present disclosure is not limited to this. In the imaging method of the present embodiment, when a user instruction is given, image processing of all patterns may be performed, and a processed image according to a request of the user may be sent.

In the above embodiments, an example in which the imaging system 10 is applied to live streaming is described. The present system 10 is not limited to live streaming in particular, and may perform post-editing on a captured video and distribute a processed video.

In the above embodiments, an operation example using a plurality of the cameras 100 in the imaging system 10 is described. In the present embodiment, the imaging system 10 may perform image processing similar to that in the above embodiments on a video captured by one of the cameras 100 and perform video distribution.

In the above-described embodiments, the example in which the image processing server 200 in the imaging system 10 performs image processing for each of the subjects 31 and 32 is described, but the present disclosure is not limited to this. In the imaging system 10 of the present embodiment, the controller 135 may cause the image processing engine 120 in the camera 100 to perform some or all of various types of processing that the controller 210 causes the image processor 260 to perform in the image processing server 200 of each of the above-described embodiments. Further, the camera 100 of the present embodiment may distribute, for example, various processed videos obtained by applying image processing on a plurality of subjects to various types of the user terminals 300 from the communication module 155 via the communication network 15.

In the present embodiment, the camera 100 includes the image sensor 115 that captures a subject image and generates the captured image 20, the image processing engine 120 as an example of an image processor that performs image processing on the captured image 20 generated by the image sensor 115, and the controller 135 that controls image processing by the image processing engine 120 based on the captured image 20. The controller 135 may acquire at least one user instruction designating a subject in a video generated from the captured image 20, and cause the image processing engine 120 to perform image processing so as to generate a video including a processed image to which different image effects are imparted between the inside and the outside of a subject region corresponding to a subject designated by a user instruction in the captured image 20 in response to at least one user instruction. In this way, it is possible to easily realize a desired image effect on a captured subject.

In the present embodiment, the camera 100 may further include the image recognizer 122 that recognizes a subject region corresponding to a subject in the captured image 20 based on the captured image 20 generated by the image sensor 115. The controller 135 controls image shooting operation by the image sensor 115 based on the subject regions R31 and R32 recognized by the image recognizer 122. In this way, a desired image effect on a captured subject can be easily realized using the image recognizer 122 of the camera 100.

In the present embodiment, the imaging system 10 includes the camera 100 as an example of an imaging apparatus and the image processing server 200 of an image processing apparatus. The camera 100 includes the image sensor 115 that captures a subject image and generates the captured image 20, and the communication module 155 as an example of a transmitter that transmits image data indicating the captured image 20 to the image processing apparatus. The image processing apparatus includes the communication interface 250 that receives image data from the camera 100, and the image processor 260 that performs, based on image data received by the communication interface 250, image processing on the captured image 20 indicated by the image data. The camera 100 or the image processing apparatus includes the controller 135 and 210 that acquire at least one user instruction designating a subject in a video generated from the captured image 20, and cause the image processor 260 to perform image processing so as to generate a video including a processed image to which different image effects are imparted between the inside and the outside of a subject region corresponding to a subject designated by a user instruction in the captured image 20 in response to at least one user instruction. In this way, it is possible to easily realize a desired image effect on a captured subject.

In the above embodiments, the color leaving processing is exemplified as an example of image processing in the imaging system 10, but the present system 10 is not limited to this, and various types of image processing may be adopted. For example, the present system 10 may perform image processing for differentiating a color tone effect between the inside and outside of a subject region. Various types of color correction such as color grading or tone mapping may be adopted as such a color tone effect. The present system 10 may perform image processing of a blurring effect instead of or in addition to such a color tone effect. Such image processing is performed by imparting a blurring effect so as to selectively blur the outside of a subject region. The blurring effect may be imparted as an image effect similar to motion blur caused by movement of a subject other than a highlighting target.

An image effect imparted in the present system 10 is not limited to the above, and may be a visual effect such as various video effects created by editing or processing a video or a video. For example, time effects such as slow motion and time lapse, or transition effects such as whiteout and fade-in and fade-out may be adopted in the present system 10. Further, special effects for creating a scene or an image that cannot be realized in reality, for example, explosion, collapse, flight, appearance of a ghost or a monster, and the like may be included. Special effects for creating a realistic video or a fantasy world by using CGs may be applied to the present system 10.

### Aspect Example

Hereinafter, various aspects according to the present disclosure will be listed.

A first aspect of the present disclosure is an imaging method including the steps of an image sensor capturing a subject image and generating a captured image, an image processor performing image processing on the captured image generated by the image sensor, and a controller controlling image processing by the image processor based on the captured image. In the present method, the controller acquires at least one user instruction designating a subject in a video generated from a captured image, and causes the image processor to perform image processing so as to generate a video including a processed image to which different image effects are imparted between the inside and the outside of a subject region corresponding to the subject designated by the user instruction in the captured image.

According to a second aspect, in the imaging method according to the first aspect, the at least one user instruction includes a plurality of user instructions for designating different subjects among a plurality of subjects in a video. The controller controls the image processor to generate a plurality of videos in which an image effect is imparted to a plurality of subject regions corresponding to different subjects according to a plurality of user instructions.

According to a third aspect, in the imaging method according to the first or second aspect, the controller acquires a user instruction via a communication interface that performs data communication with at least one user terminal corresponding to the at least one user instruction. The present method further includes a step of transmitting, by the communication interface, video data indicating a video generated according to a user instruction to a user terminal corresponding to the user instruction.

According to a fourth aspect, in the imaging method according to any of the first to third aspects, the subject region is a region along an outer shape of the subject in the captured image. The image processor generates a processed image so as to make image effects different along an outer shape of a subject designated by a user instruction in a captured image.

According to a fifth aspect, the imaging method according to any of the first to fourth aspects further includes a step of recognizing a subject region corresponding to a subject in a captured image generated by the image sensor based on the captured image. The controller causes the image processor to perform image processing so as to impart an image effect on a subject region corresponding to a subject designated by a user instruction among recognized subject regions based on a recognition result of the subject regions.

According to a sixth aspect, in the imaging method according to any of the first to fifth aspects, the image effect is an effect in which a color tone is separately adjusted between the inside and the outside of a subject region.

A seventh aspect is an image processing apparatus including a receiver that receives image data including a captured image in which a subject image is captured by an imaging apparatus, an image processor that performs image processing on a captured image included in image data received by the receiver, and a controller that controls the image processing by the image processor based on the captured image. The controller acquires at least one user instruction designating a subject in a video generated from a captured image, and causes the image processor to perform image processing so as to generate a video including a processed image to which different image effects are imparted between the inside and the outside of a subject region corresponding to the subject indicated by the user instruction in the captured image.

According to an eighth aspect, in the image processing apparatus according to the seventh aspect, the receiver receives a plurality of pieces of image data from a plurality of imaging apparatuses, and the controller causes the image processor to perform image processing so as to generate a video based on a plurality of pieces of the image data received from a plurality of the imaging apparatuses via the receiver.

A ninth aspect is an imaging apparatus including an image sensor that captures a subject image and generates a captured image, an image processor that performs image processing on the captured image generated by the image sensor, and a controller that controls image processing by the image processor based on the captured image. The controller acquires at least one user instruction designating a subject in a video generated from a captured image, and causes the image processor to perform image processing so as to generate a video including a processed image to which different image effects are imparted between the inside and the outside of a subject region corresponding to the subject designated by the user instruction in the captured image.

According to a tenth aspect, the imaging apparatus according to the ninth aspect further includes an image recognizer that recognizes a subject region corresponding to a subject in a captured image generated by the image sensor based on the captured image. The controller controls image shooting operation by the image sensor based on a subject region recognized by the image recognizer.

An eleventh aspect is an imaging system including an imaging apparatus and an image processing apparatus. The imaging apparatus includes an image sensor that captures a subject image and generates a captured image; and a transmitter that transmits image data indicating the captured image to the image processing apparatus. The image processing apparatus includes a receiver that receives the image data from the imaging apparatus, and an image processor that performs, based on image data received by the receiver, image processing on a captured image indicated by the image data. The imaging apparatus or the image processing apparatus includes a controller that acquires at least one user instruction designating a subject in a video generated from a captured image, and causes the image processor to perform image processing so as to generate a video including a processed image to which different image effects are imparted between the inside and the outside of a subject region corresponding to the subject designated by the user instruction in the captured image.

As described above, the embodiment is described as an exemplification of the technique in the present disclosure. For this purpose, the accompanying drawings and the detailed description are provided.

Accordingly, the constituent elements described in the accompanying drawings and the detailed description may include not only a constituent element essential for solving the problem, but also a constituent element not essential for solving the problem in order to exemplify the technique. For this reason, it should not be recognized that those non-essential constituent elements are essential just because those non-essential constituent elements are described in the accompanying drawings and the detailed description.

Further, the above-described embodiment is provided to exemplify the technique in the present disclosure, and hence it is possible to make various changes, replacements, additions, omissions, and the like within the scope of claims or the scope equivalent to claims.

The present disclosure is applicable to various applications in which image processing is performed on an image in which a subject is captured.

1. An imaging method comprising:
capturing, by an image sensor, a subject image to generate a captured image;
performing, by an image processor, image processing on the captured image generated by the image sensor; and
controlling, by a controller, the image processing by the image processor, based on the captured image, wherein the controller
acquires at least one user instruction designating a subject in a video generated from the captured image, and
causes the image processor to perform the image processing to generate the video including a processed image having an image effect different between an inside and an outside of a subject region corresponding to the subject designated by the user instruction in the captured image.

2. The imaging method according to claim 1, wherein
the at least one user instruction includes a plurality of user instructions designating different subjects among a plurality of subjects in the video, and
the controller controls the image processor to generate a plurality of videos according to the plurality of user instructions, the plurality of videos each having the image effect for each of a plurality of subject regions corresponding to the different subjects respectively.

3. The imaging method according to claim 1, wherein
the controller acquires the user instruction via a communication interface that communicates data with at least one user terminal corresponding to the at least one user instruction, and
the imaging method further comprises transmitting, by the communication interface, video data to the user terminal corresponding to the user instruction, the video data indicating the video generated according to the user instruction.

4. The imaging method according to claim 1, wherein
the subject region is a region having a shape along an outer shape of the subject in the captured image, and
the image processor generates the processed image to apply the image effect to be different along the outer shape of the subject designated by the user instruction in the captured image.

5. The imaging method according to claim 1,
further comprising recognizing the subject region, based on the captured image, the subject region corresponding to the subject in the captured image generated by the image sensor,
wherein the controller causes the image processor to perform the image processing to apply the image effect on the subject region corresponding to the subject designated by the user instruction among recognized subject regions, based on a recognition result of the subject regions.

6. The imaging method according to claim 1, wherein the image effect is an effect in which a color tone is separately tuned between the inside and the outside of the subject region.

7. An image processing apparatus comprising:
a receiver that receives image data including a captured image by an imaging apparatus capturing a subject image;
an image processor that performs image processing on the captured image included in the image data received by the receiver; and
a controller that controls the image processing by the image processor, based on the captured image, wherein the controller
acquires at least one user instruction designating a subject in a video generated from the captured image, and
causes the image processor to perform image processing to generate the video including a processed image having an image effect different between an inside and an outside of a subject region corresponding to the subject indicated by the user instruction in the captured image.

8. An imaging apparatus comprising:
an image sensor that captures a subject image to generate a captured image;
an image processor that performs image processing on the captured image generated by the image sensor; and
a controller that controls the image processing by the image processor, based on the captured image wherein the controller
acquires at least one user instruction designating a subject in a video generated from the captured image, and
causes the image processor to perform the image processing to generate the video including a processed image having an image effect between an inside and an outside of a subject region corresponding to the subject designated by the user instruction in the captured image.

9. An imaging system comprising:
the imaging apparatus according to claim 8 with the image processor as a first image processor; and
an image processing apparatus, wherein
the imaging apparatus further comprises a transmitter that transmits image data indicating the captured image to the image processing apparatus,
the image processing apparatus comprises:
a receiver that receives the image data from the imaging apparatus; and
a second image processor that performs, based on the image data received by the receiver, the image processing on the captured image indicated by the image data, and
the imaging apparatus or the image processing apparatus:
acquires at least one user instruction designating the subject in the video generated from the captured image; and
causes the image processing to generate the video including the processed image having the image effect different between the inside and the outside of the subject region corresponding to the subject designated by the user instruction in the captured image.
